(19) United States
(12) Patent Application Publication
(10) Pub. No.: US 2022/0028019 A1
(43) Pub. Date: Jan. 27, 2022

(54) METHOD AND SYSTEM FOR PROVIDING MOBILE EDUCATION SERVICE

(71) Applicants: Hyundai Motor Company, Seoul (KR); Kia Motors Corporation, Seoul (KR)

(72) Inventors: Jin Ho HWANG, Cheonan-si (KR); Dong Eun CHA, Hwaseong-si (KR); Sang Heon LEE, Seoul (KR)

(73) Assignees: Hyundai Motor Company, Seoul (KR); Kia Motors Corporation, Seoul (KR)

(21) Appl. No.: 17/099,371

(22) Filed: Nov. 16, 2020

(30) Foreign Application Priority Data
Jul. 22, 2020 (KR) 10-2020-0091122

(51) Int. Cl. G06Q 50/20; G09B 19/00; G06Q 50/30; G06Q 10/06; G06Q 30/08; G06N 5/02; G05D 1/00; B60R 25/01; B60R 25/20; G05D 1/02

(52) U.S. Cl. CPC G06Q 50/205; G09B 19/00; G06Q 50/30; G06Q 10/06315; G06Q 30/08; G06Q 2240/00; G05D 1/0088; G05D 1/0011; B60R 25/01; B60R 25/20; G05D 1/0225; G06N 5/02

(57) ABSTRACT

A method and system for providing a mobile education service, in which a user rides a vehicle allocated according to a schedule is provided with an educational content during transportation, facilitating efficient use of a transportation time, and safe riding in and alighting from the vehicle at an educational place.

### CROSS REFERENCE TO RELATED APPLICATION

The present application claims priority to Korean Patent Application No. 10-2020-0091122, filed Jul. 22, 2020, the entire contents of which is incorporated herein for all purposes by this reference.

### BACKGROUND OF THE INVENTION

### Field of the Invention

The present invention relates to a method and system for providing a mobile education service, which enable efficient time management and safe transportation of a student by allocating a vehicle based on educational data of the student and providing a content to the student in the vehicle even during transportation.

### Description of Related Art

Conventionally, in a case of attending a school or institute, a student goes to the school or institute on foot or by shuttle bus or public transit. In the instant case, the student needs to make a schedule for transportation between educational places in advance, and select and take a means of transportation every time the student moves.

Furthermore, in a case of transportation between educational places using such a means of transportation, a transportation time may vary every time, and it may be difficult to efficiently use the transportation time.

Furthermore, an underage student is not protected from an external danger during such transportation, and thus protectors cannot but feel anxiety for that.

In recent years, an autonomous vehicle has been actively developed, and in a case where such an autonomous vehicle is introduced, it is possible to more effectively use a transportation time of a student and promote safety. Therefore, there is a need to develop an education service suitable for an autonomous driving environment which is expected to be expanded in the future.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a method and system for providing a mobile education service, in which a student may ride a vehicle allocated according to a schedule and be provided with an educational content during transportation to efficiently use a transportation time, the student may safely ride or alight from the vehicle at home or at an educational place after the transportation, and riding in or alighting from the vehicle may be confirmed by use of a dedicated user terminal.

According to various exemplary embodiments of the present invention, a method for providing a mobile education service includes: generating educational data including a content to be provided to a student during transportation in a vehicle; allocating a vehicle required for the transportation and matching a corresponding student to the allocated vehicle based on the educational data; and providing, when the transportation using the allocated vehicle is performed, the content according to the educational data to the matched student in the moving vehicle.

The method may further include confirming riding of the matched student in the allocated vehicle by checking the riding of the matched student at a departure site and transmitting a result of the checking the riding to a server before the providing of the content; and confirming alighting of the matched student from the allocated vehicle by checking the alighting of the matched student at a destination site after the transportation using the allocated vehicle and transmitting a result of the checking the alighting to the server after the providing of the content to the matched student, wherein the vehicle is an autonomous vehicle.

In the confirming of the riding and the confirming of the alighting, the riding and alighting of the matched student may be checked by authenticating the student through an authenticating unit in the vehicle or the server.

In the confirming of the riding and the confirming of the alighting, a notification service may be provided to a designated user terminal after completing the checking of the riding and the alighting.

The method may further include, after the providing of the content to the matched student, opening a door of the vehicle after checking safety around the vehicle or confirming that a seat belt of the vehicle is released when the allocated vehicle arrives at the destination site.

In the providing of the content, location information related to the student may be provided to a designated user terminal.

In the providing of the content, a teacher or an artificial intelligence educational unit matched to the student riding in the vehicle may tutor the student.

The teacher or artificial intelligence educational unit may be selectively assigned to a corresponding vehicle according to the number of students or the number of contents.

According to various exemplary embodiments of the present invention, a system for providing a mobile education service includes: a storage unit that is configured to store educational data including a content to be provided to a student during transportation in a vehicle; a communication unit that performs communication with a vehicle or designated user terminal; a vehicle allocation determining unit that is configured to allocate the vehicle required for the transportation and matching a corresponding student to the allocated vehicle based on the educational data; and a content providing unit that is configured to provide, when the transportation using the allocated vehicle is performed, the content according to the educational data to the matched student in the moving vehicle.

The system may further include a student authenticating unit that checks riding the matched student in the allocated vehicle or alighting the matched student from the allocated vehicle through communication between the communication unit and the vehicle or designated user terminal when the matched student rides in the allocated vehicle or alights from the allocated vehicle.

The student authenticating unit may provide a notification to the designated user terminal when the checking of the riding or the alighting of the matched student is completed.

The system may further include a safety controller that is configured to open a door of the vehicle after checking safety around the vehicle or confirming that a seat belt of the vehicle is released when the allocated vehicle arrives at a destination site.

The content providing unit may provide a content by assigning a matched teacher or an artificial intelligence educational unit according to the number of students or the number of contents to tutor the student matched to the vehicle allocated through the vehicle allocation determining unit.

The educational data may further include data regarding an education time, an educational place, and transportation between educational places.

The educational places may include a hub and a plurality of individual educational places, the hub may correspond to a terminal of vehicles, and the vehicle may move between the hub and each of the individual educational places.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system for providing a mobile education service according to various exemplary embodiments of the present invention.

FIG. 2 is a schematic diagram of a vehicle that performs communication with the system for providing a mobile education service according to the exemplary embodiment of the present invention.

FIG. 3 is a diagram illustrating movement of a vehicle between a hub and a plurality of individual educational spaces in the system for providing a mobile education service according to the exemplary embodiment of the present invention.

FIG. 4 is a flowchart of a method for providing a mobile education service according to various exemplary embodiments of the present invention.

FIG. 5 is a flowchart of a method of managing safety of a student at the time of riding in or alighting from the vehicle, in the method for providing a mobile education service according to the exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

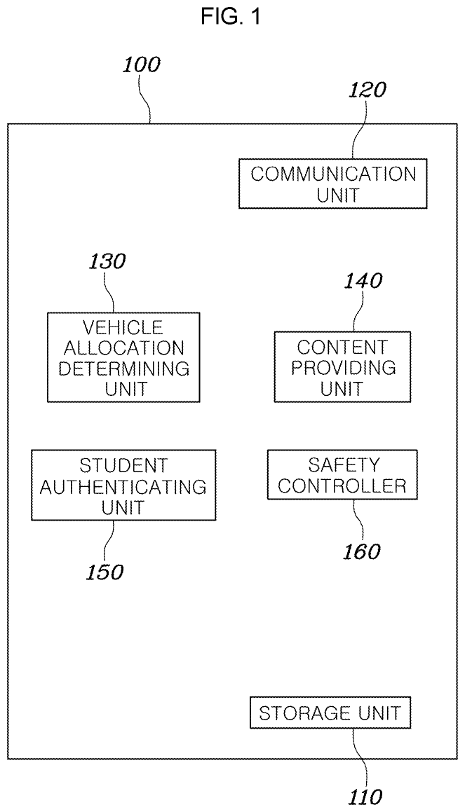

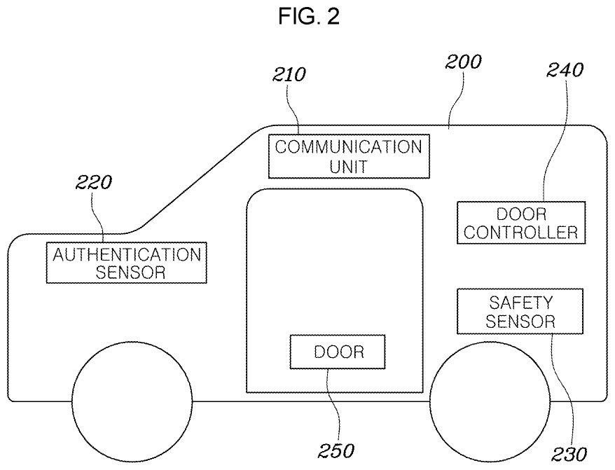

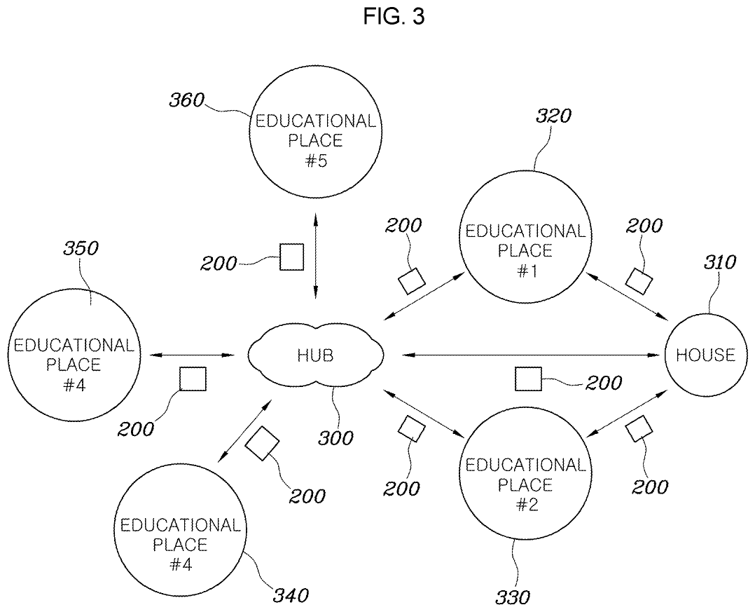

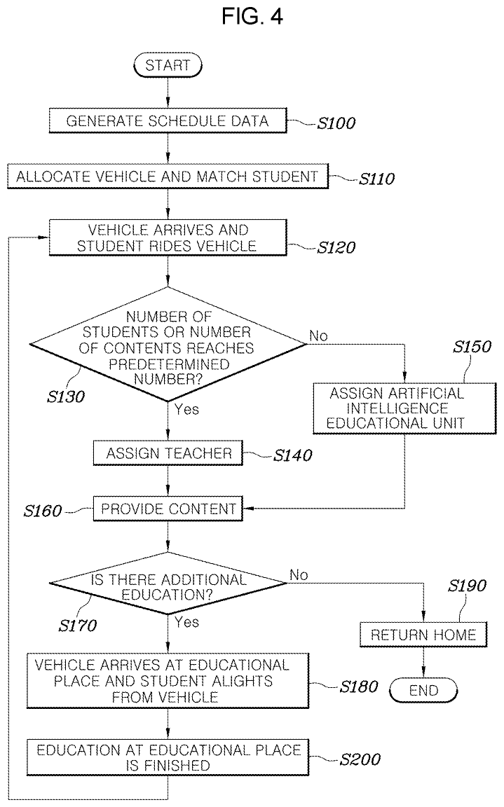

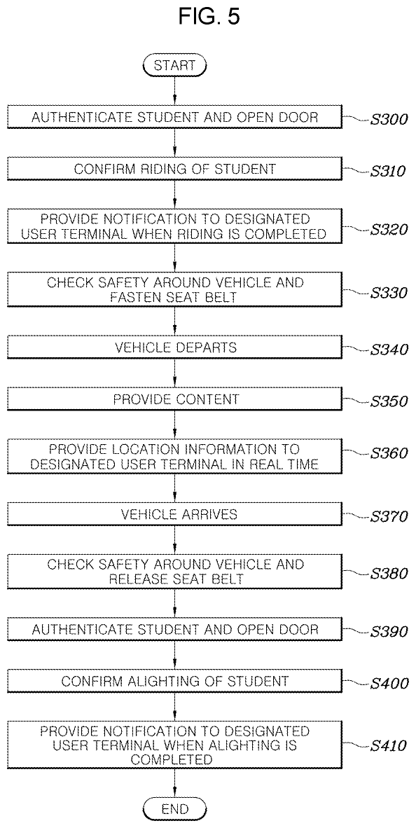

FIG. 1 is a schematic diagram of a system for providing a mobile education service according to various exemplary embodiments of the present invention, FIG. 2 is a schematic diagram of a vehicle that performs communication with the system for providing a mobile education service according to the exemplary embodiment of the present invention, FIG. 3 is a diagram illustrating movement of a vehicle between a hub and a plurality of individual educational spaces in the system for providing a mobile education service according to the exemplary embodiment of the present invention, FIG. 4 is a flowchart of a method for providing a mobile education service according to various exemplary embodiments of the present invention, and FIG. 5 is a flowchart of a method of managing safety of a student at the time of riding in or alighting from the vehicle, in the method for providing a mobile education service according to the exemplary embodiment of the present invention.

FIG. 1 is a schematic diagram of a system for providing a mobile education service according to various exemplary embodiments of the present invention. A control system 100 for providing a mobile education service according to various exemplary embodiments of the present invention includes: a storage unit 110 that stores educational data including a content to be provided to a student during transportation in a vehicle; a communication unit 120 that performs communication with a vehicle or a designated user terminal; a vehicle allocation determining unit 130 that allocates a vehicle required for the transportation and matches a corresponding student to the allocated vehicle based on the educational data; and a content providing unit 140 that provides, when transportation using the allocated vehicle is performed, the content according to the educational data to the matched student in the moving vehicle. The control system 100 for providing a mobile education service according to various exemplary embodiments of the present invention may be, for example, a central server which may be connected to a user terminal, a vehicle, a hub, an educational place, or the like via a network and perform communication. The educational data may further include data regarding an education time, an educational place, and transportation between educational places.

The control system 100 for providing a mobile education service according to various exemplary embodiments of the present invention may be, for example, a central server. First, an educational content requested from a terminal of a student or protector, location information related to a house, a school, or the like, of the student, and a daily, weekly, or monthly class schedule of a school or institute are input to the control system 100 for providing a mobile education service through an on-line platform. The control system 100 for providing a mobile education service generates educational data for a student and stores the educational data in the storage unit 110, the educational data including a departure time and an arrival time at each place, a transportation time, a transportation route, and the like.

Accordingly, the vehicle allocation determining unit 130 determines an optimum route between respective educational places based on the educational data for each student, stored in the storage unit 110, allocates a vehicle required for transportation of a student, and matches a corresponding student. The vehicle allocated as described above transports a student according to a planned schedule, and the content providing unit 140 provides, to the student in the moving vehicle, a content requested in advance. Furthermore, in the moving vehicle, various activities such as taking a rest, providing snacks, and playing a simple game may be provided in addition to education. Therefore, it is possible to care for a student in various ways. As a result, a student need not worry about a means of transportation for transportation between educational places, a transportation time may be reduced, and an educational content is provided during the transportation time, facilitating efficient use of time. Furthermore, parents may feel less concern about a safety accident which may occur during transportation of a student.

The control system 100 for providing a mobile education service may provide, in a case where information on supplies or homework of a school or institute of a student is received in advance, a notification therefor before riding a vehicle, and may provide a notification for vehicle allocation before riding so that a student may ride a vehicle in time, promoting convenience of a student.

Meanwhile, the control system 100 for providing a mobile education service may further include a student authenticating unit 150 that checks riding or alighting through communication between the communication unit 120 and a vehicle or designated user terminal when a matched student rides or alights from an allocated vehicle in FIG. 2. The student authenticating unit 150 may provide a notification to the designated user terminal when checking of riding or alighting of the matched student is completed. The control system 100 for providing a mobile education service may further include a safety controller 160 that opens a door of a vehicle after checking safety around the vehicle or confirming that a seat belt of the vehicle is released when the allocated vehicle arrives at a destination site.

When a vehicle is allocated, a student goes through authentication to check whether the student is a student matched to the vehicle through the student authenticating unit 150 before riding the vehicle. When the student safely rides the vehicle after the authentication, a notification indicating safe riding is provided to a designated user terminal of the student or a protector of the student such that the student or the protector of the student may conveniently confirm the safe riding of the student. Here, the user terminal means various communication devices such as a smartphone, a tablet personal computer (PC), and a PC.

Furthermore, after the riding of the student, the vehicle leaves after safety around the vehicle is checked through the safety controller 160 and a seat belt of the student is fastened, guaranteeing safe transportation of the student. Similarly, when the student alights from the vehicle, the student goes through authentication to check whether the student is a student matched to the vehicle after safety around the vehicle is checked through the safety controller 160 and the seat belt of the student is released. When the student safely alights from the vehicle after the authentication, a notification indicating safe alighting is provided to the designated user terminal of the student or the protector of the student such that the student or the protector of the student may conveniently confirm the safe alight of the student. Meanwhile, it is possible to check attendance of a student by use of such an authentication procedure, conveniently managing attendance and absence of a student.

Furthermore, the content providing unit 140 may provide a content by assigning a matched teacher or an artificial intelligence educational unit according to the number of students or the number of contents, tutoring a student matched to a vehicle allocated through the vehicle allocation determining unit 130. For example, in a case where the number of students riding in the vehicle exceeds a predetermined number, a matched teacher may ride the vehicle together with the students to provide a content or assist in education, and in a case where the number of students riding in the vehicle is equal to or less than the predetermined number, an artificial intelligence educational unit may provide a content or assist in education in the vehicle.

Similarly, in a case where the number of contents desired by a student riding in the vehicle is less than a predetermined number, the teacher rides the vehicle together with the student, and in a case where the number of contents exceeds the predetermined number, the teacher may be substituted with the artificial intelligence educational unit. In other words, in a case where scheduling is performed so that the same content is provided to a plurality of students, one teacher rides the vehicle and provides education, and in a case where it is required that different contents are provided to a plurality of students, education is performed through the artificial intelligence educational unit using a personalized terminal. Here, the artificial intelligence educational unit may be a speech, an image, a device, a robot or the like, provided by artificial intelligence. The artificial intelligence educational unit may monitor a learning activity, a body condition, or the like, of a student in real time, may assist a teacher and directly provide an educational content, may interact with a student, and may provide a vehicle food storage service and food providing service, serving to collectively manage education, and personal nutrition and health of a student.

FIG. 2 is a schematic diagram of a vehicle that performs communication with the system for providing a mobile education service according to the exemplary embodiment of the present invention. A vehicle 200 includes a communication unit 210 for communication with the control system 100 for providing a mobile education service; an authentication sensor 220 for authentication at the time of riding of a student; a safety sensor 230 for checking safety around the vehicle at the time of riding or alighting of the student; a door controller 240 for opening and closing a vehicle door; and a vehicle door 250.

A student who wants to ride or alight from the vehicle may go through authentication by the student authenticating unit 150 by use of a terminal of the student or the authentication sensor 220 of the vehicle. An authentication method includes a method of using a keyword and various biometric authentication methods such as a method of using fingerprints or iris. When a student rides or alights from the vehicle, the safety sensor 230 checks safety around the vehicle, and confirms that a seat belt is fastened or released, and transmits a control signal to the safety controller 160 of the control system 100 for providing a mobile education service through the communication unit 210 of the vehicle and the communication unit 120 of the control system 100 for providing a mobile education system. When the safety of the student is ensured, the safety controller 160 finally opens or closes the vehicle door 250 through the door controller 240 of the vehicle. As a result, a student rides or alights from the vehicle in a state where the student is confirmed as a student matched to the allocated vehicle, and safety is ensured.

Meanwhile, in a case where the vehicle is an autonomous vehicle which may autonomously drive along a designated route and perform real-time monitoring of a vehicle condition, it is possible to more smoothly assist in providing the mobile education service according to various exemplary embodiments of the present invention.

Furthermore, the vehicle may include a rear-view display to provide information to a following vehicle at the time of riding or alighting of a student, preventing an accident in advance. The vehicle may include a safety light for night driving to enable safe riding or alighting of a student at night. The vehicle may include an information display in an internal door trim to provide information on a location where a student alights from the vehicle, institute information, or the like, promoting convenience of the student.

Meanwhile, the vehicle may perform intelligent air conditioning, an illuminance control, a noise control, an AV control, and the like, block a harmful substance such as fine dust, sterilize the internal with an ultraviolet light emitting diode (UV LED) when no passenger is in the vehicle, include a washable seat and floor mat, or the like, providing a comfortable education environment according to an education situation. A delivery robot or the like may go through authentication and be docked on the vehicle from the outside thereof such that a student may conveniently receive goods even in the vehicle. Furthermore, the vehicle may also provide a personal user authentication locker that a student may use, promoting convenience of a student.

FIG. 3 is a diagram illustrating an example of a transportation route of the vehicle that performs communication with the system for providing a mobile education service according to the exemplary embodiment of the present invention. The educational places in the educational data stored in the storage unit 110 of the system for providing a mobile education service include a hub 300 and a plurality of individual educational places 320, 330, 340, 350, and 360. The hub corresponds to a terminal of vehicles, and the vehicle 200 may move between the hub and each of the individual educational places. The vehicle 200 may move between a student's house 310 and the hub 300, between the student's house 310 and the individual educational place 320, 330, 340, 350, or 360, and between the hub 300 and the individual educational place 320, 330, 340, 350, or 360, and does not may directly move between the individual educational places 320, 330, 340, 350, and 360. This is because a route of the vehicle becomes significantly complicated in a case where the vehicle directly moves between a plurality of individual educational places 320, 330, 340, 350, and 360, and it is difficult to allocate the vehicle and provide a content in consideration of the complicated route.

For example, the vehicle may move from the house 310 to the individual educational place 320, 330, 340, 350, or 360, or the hub 300, but the vehicle returns to the house 310 or the hub 300 provided as a terminal after finishing education at the individual educational place 320, 330, 340, 350, or 360 such that it is possible to efficiently allocate the vehicle and smoothly provide a content during transportation. In the instant case, there is a disadvantage that the student necessarily passes through the hub 300 at the time of transportation. However, since education or other services are provided during transportation, it may be said that an advantage resulting from such a service outweighs the disadvantage.

The hub is configured as a central terminal for vehicles to be allocated. In the hub, a vehicle may be docked on a designated docking station, vehicle charging may be supported at the time of docking. Furthermore, the hub may include a public service area for students, such as a space for various types of education using virtual experience, media, or the like, a space for a large-scale class, sports facilities, a library, a rest area, or an entertainment space. Such spaces may be implemented by a docked vehicle.

Furthermore, in the hub, in a case where contents desired by students are not provided or there are excessive or insufficient number of enrollees, student distribution such as relocation or exchange between a plurality of hubs may be performed, and a comprehensive education support service may be provided to support an overall education process such as scheduling, content preparation, service linkage, mobile classes, education center administrative management, real-time monitoring, or meeting with parents.

Meanwhile, the educational space to which a student is transported from the hub includes a field trip space such as an ecological portion or a museum, in addition to a student's house, school, or institute. Therefore, students who are provided with a content during transportation may directly go to a field trip or have practical exercise.

Therefore, as learning except for sports, exercise, a field trip, or the like for students proceeds in the vehicle or hub, it is possible to significantly reduce a transportation time and enable efficient time management.

FIG. 4 is a flowchart of a method for providing a mobile education service according to various exemplary embodiments of the present invention. The method for providing a mobile education service according to various exemplary embodiments of the present invention includes: generating educational data including a content to be provided to a student during transportation (S100); allocating a vehicle required for the transportation and matching a corresponding student to the allocated vehicle based on the educational data (S110); and providing, when transportation using the allocated vehicle is performed, the content according to the educational data to the matched student in the moving vehicle (S160).

Accordingly, a student may be transported comfortably and safely between educational places using an allocated vehicle according to a schedule generated in advance, and may concentrate only on a content provided in the vehicle, significantly increasing learning efficiency. Accordingly, whether or not there is additional education is determined (S170), and after education in an educational place is finished (S200), the student rides the allocated vehicle again and is provided with an additional content during transportation to an educational place or hub in a case where there is additional education, and the student returns home (S190) in a case where there is not additional education.

Meanwhile, in the providing of the content (S160), a teacher or an artificial intelligence educational unit matched to the student riding in the vehicle may tutor the student. The teacher or artificial intelligence educational unit may be selectively assigned (S130, S140, and S150) to a corresponding vehicle according to the number of students or the number of contents. Accordingly, in the providing of the content, it is possible to comprehensively care for the student. For example, the teacher or artificial intelligence educational unit may assist in providing a content, monitor the student, or manage health of the student.

In an exemplary embodiment of the present invention, when the number of students or the number of contents is equal to or greater than a predetermined number, the teacher is assigned to the corresponding vehicle (S130 and S140).

In an exemplary embodiment of the present invention, when the number of students or the number of contents is lower than a predetermined number, an artificial intelligence educational unit is assigned to the corresponding vehicle (S130 and S150).

FIG. 5 is a flowchart of a method of managing safety of a student at the time of riding in or alighting from the vehicle, in the method for providing a mobile education service according to the exemplary embodiment of the present invention. The method for providing a mobile education service according to various exemplary embodiments of the present invention may further include: confirming riding by checking riding of the matched student at a departure site and transmitting a checking result to a server (S310) before the providing of the content; and confirming alighting by checking alighting of the matched student from the vehicle at a destination site after the transportation using the allocated vehicle and transmitting a checking result to the server (S400) after the providing of the content (S350), in which the vehicle is an autonomous vehicle.

Furthermore, in the confirming of the riding (S310) and the confirming of the alighting (S400), the riding and alighting of the matched student may be checked by authenticating the student through an authenticating unit in the vehicle or server (S300 and S390). Furthermore, in the confirming of the riding and the confirming of the alighting, a notification service may be provided to a designated user terminal (S320 and S410) after completing the checking of the riding and the alighting.

Accordingly, it is possible to perform authentication to check whether or not the student is a matched student at the time of riding in or alighting from the allocated vehicle according to the educational data, and the student or a protector of the student may conveniently confirm proper riding and alighting of the student.

Meanwhile, the method for providing a mobile education service may further include, after the providing of the content to the matched student, opening a door of the vehicle after checking safety around the vehicle or confirming that a seat belt of the vehicle is released when the allocated vehicle arrives at the destination site (S380 and S390). Accordingly, safety around the vehicle is checked and fastening or releasing of the seat belt is confirmed before the riding and alighting of the student such that it is possible to ensure safety of the student at the time of the riding and alighting. Furthermore, in the providing of the content, a maximum speed of the vehicle may be limited or the like, promoting safety of the student in the moving vehicle.

Furthermore, in the providing of the content, location information related to the student may be provided to the designated user terminal (S360). As a result, the student or the protector of the student may check the location of the student through the terminal any time, and thus may use the method according to various exemplary embodiments of the present invention without anxiety. Such a notification service includes a service of providing a riding or alighting notification or location information notification to the terminal of the student or the protector of the student, and a comprehensive student caring and monitoring service of monitoring an in-vehicle situation and providing health information.

With the method and system for providing a mobile education service according to various exemplary embodiments of the present invention, a student may reflect a schedule in advance, ride a vehicle allocated at a desired place according to the schedule, and be provided with an educational content during transportation to efficiently use a transportation time, the student may safely ride or alight from the vehicle at home, at a hub, or at an individual educational place after the transportation, and the riding and alighting of the student may be confirmed by use of a dedicated user terminal such that the student or a protector of the student may use the method and system for providing a mobile education service according to various exemplary embodiments of the present invention without anxiety.

According to various exemplary embodiments of the present invention, a student may ride a vehicle allocated according to a schedule and be provided with an educational content during transportation to efficiently use a transportation time, the student may safely ride or alight from the vehicle at home or at an educational place after the transportation, and riding in or alighting from the vehicle may be confirmed by use of a dedicated user terminal.

Furthermore, the term “controller”, “control unit” or “control device” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller or the control unit may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a controller, and the controller may be configured by a plurality of controllers, or an integrated single controller.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of providing a mobile education service, the method comprising:
generating, by a control system, educational data including a content to be provided to a student during transportation in a vehicle;
allocating, by the control system, a vehicle required for the transportation and matching a corresponding student to the allocated vehicle according to the educational data; and
providing, by the control system, when the transportation using the allocated vehicle is performed, the content according to the educational data to the matched student in the moving vehicle.

2. The method of claim 1, further including:
confirming riding of the matched student in the allocated vehicle by checking the riding of the matched student at a departure site and transmitting a result of the checking the riding to a server before the providing of the content; and
confirming alighting of the matched student from the allocated vehicle by checking the alighting of the matched student at a destination site after the transportation using the allocated vehicle and transmitting a result of the checking the alighting to the server after the providing of the content to the matched student,
wherein the allocated vehicle is an autonomous vehicle.

3. The method of claim 2, wherein in the confirming of the riding and the confirming of the alighting, the riding and the alighting of the matched student are checked by authenticating the student through an authenticating unit in the allocated vehicle or the server.

4. The method of claim 2, wherein in the confirming of the riding and the confirming of the alighting, a notification service is provided to a predetermined user terminal after completing the checking of the riding and the alighting.

5. The method of claim 1, further including: after the providing of the content to the matched student, opening a door of the allocated vehicle after checking safety around the allocated vehicle or confirming that a seat belt of the allocated vehicle is released when the allocated vehicle arrives at a destination site.

6. The method of claim 1, wherein in the providing of the content, location information related to the student is provided to a predetermined user terminal.

7. The method of claim 1, wherein in the providing of the content, a teacher or an artificial intelligence educational unit matched to the student riding in the allocated vehicle is assigned to the allocated vehicle to tutor the student.

8. The method of claim 7, wherein the teacher or the artificial intelligence educational unit is selectively assigned to a corresponding vehicle according to a number of students or a number of contents.

9. The method of claim 8, wherein when the number of students or the number of contents is equal to or greater than a predetermined number, the teacher is assigned to a corresponding vehicle.

10. The method of claim 8, wherein when the number of students or the number of contents is lower than a predetermined number, an artificial intelligence educational unit is assigned to a corresponding vehicle.

11. The method of claim 1, wherein the control system including:
a storage unit that is configured to store the educational data;
a communication unit that is configured to perform communication with the vehicle or a predetermined user terminal;
a vehicle allocation determining unit that is configured to allocate the vehicle required for the transportation and to match the corresponding student to the allocated vehicle according to the educational data; and
a content providing unit that is configured to provide, when the transportation using the allocated vehicle is performed, the content according to the educational data to the matched student in the moving vehicle.

12. A control system of providing a mobile education service, the system comprising:
a storage unit that is configured to store educational data including a content to be provided to a student during transportation in a vehicle;
a communication unit that is configured to perform communication with the vehicle or a predetermined user terminal;
a vehicle allocation determining unit that is configured to allocate the vehicle required for the transportation and to match a corresponding student to the allocated vehicle according to the educational data; and
a content providing unit that is configured to provide, when the transportation using the allocated vehicle is performed, the content according to the educational data to the matched student in the moving vehicle.

13. The control system of claim 12, further including a student authenticating unit that checks riding the matched student in the allocated vehicle or alighting the matched student from the allocated vehicle through communication between the communication unit and the allocated vehicle or the predetermined user terminal when the matched student rides in the allocated vehicle or alights from the allocated vehicle.

14. The control system of claim 13, wherein the student authenticating unit provides a notification to the predetermined user terminal when the checking of the riding or the alighting of the matched student is completed.

15. The control system of claim 12, further including a safety controller that is configured to open a door of the vehicle after checking safety around the vehicle or confirming that a seat belt of the vehicle is released when the allocated vehicle arrives at a destination site.

16. The control system of claim 12, wherein the content providing unit is configured to provide the content by assigning a matched teacher or an artificial intelligence educational unit according to a number of students or a number of contents to tutor the student matched to the vehicle allocated through the vehicle allocation determining unit.

17. The control system of claim 16, wherein when the number of students or the number of contents is equal to or greater than a predetermined number, the teacher is assigned to the vehicle.

18. The control system of claim 16, wherein when the number of students or the number of contents is lower than a predetermined number, the artificial intelligence educational unit is assigned to the vehicle.

19. The control system of claim 12, wherein the educational data further includes data regarding an education time, an educational place, and transportation between educational places.

20. The control system of claim 19, wherein the educational place includes a hub and a plurality of individual educational places, the hub corresponds to a terminal of vehicles, and the allocated vehicle moves between the hub and each of the individual educational places.
